(19) United States
(12) Patent Application Publication
(10) Pub. No.: US 2025/0312775 A1
(43) Pub. Date: Oct. 9, 2025

(54) AMMONIA SYNTHESIS CATALYST AND PROCESS FOR ITS PREPARATION

(71) Applicant: CASALE SA, Lugano (CH)

(72) Inventors: Pierdomenico BIASI, Como (IT); Cristina PIZZOLITTO, Zoppola (PN) (IT); Valentin SMEETS, Wanze (BE); Eric GAIGNEAUX, Blanmont (BE)

(21) Appl. No.: 18/863,045

(22) PCT Filed: May 9, 2023
(86) PCT No.: PCT/EP2023/062277

§ 371 Date: Nov. 5, 2024

(30) Foreign Application Priority Data
May 10, 2022 (EP) 22172459.4

(51) Int. Cl. B01J 23/78; B01J 37/00; B01J 37/04; B01J 37/06; B01J 37/16; C01C 1/04

(52) U.S. Cl. CPC B01J 23/78; B01J 37/009; B01J 37/04; B01J 37/06; B01J 37/16; C01C 1/0411

(57) ABSTRACT

It is disclosed a process for synthesizing an ammonia synthesis catalyst comprising the steps of providing a transition metal precursor and contacting said transition metal precursor with a solution to form a modified solution, providing a catalyst support and contacting said catalyst support with said modified solution to form a suspension; desiccating said suspension to obtain a solid powder; mixing said solid powder with a hydride compound to yield said ammonia synthesis catalyst.

### FIELD OF APPLICATION

The invention pertains to an ammonia synthesis catalyst, a process for its preparation and its use in the ammonia industry.

### PRIOR ART

Ammonia is synthesized industrially by reacting nitrogen and hydrogen at elevated temperature and pressure in presence of a suitable catalyst.

The catalyst has to accomplish two functions during the synthesis, namely the activation of molecular hydrogen and nitrogen to form reactive atomic species. Such activation typically involves electronic transfer reactions promoted by the high temperature and the presence of promoters with electron-donating properties.

Several catalysts are active for the synthesis of ammonia. Historically, iron (Fe)-based catalysts comprising Fe₃O₄ and a few percentages of Al₂O₃ and K₂O have been used for the ammonia synthesis in the temperature range of 400 to 500° C. and in the pressure range 150 to 300 bar. More recently, ruthenium (Ru)-based catalysts made it possible to synthesize ammonia under milder conditions e.g. at 250-400° C. and a pressure of 110 bar or lower.

Nowadays, commonly used catalysts for the synthesis of ammonia are supported catalysts wherein the active catalytic elements are dispersed onto supports to reduce their manufacturing cost, increase the dispersion of the active species, and in some cases promote the activation of nitrogen through electron donation.

For instance, known supported catalysts for the synthesis of ammonia include Ru/C, Ru/MgO and Ru/CaO. In addition to ruthenium, other transition metals can be used including Fe, Co, Co—Mo or Ni—Mo.

In the art, there is a growing interest in finding ammonia synthesis catalysts characterized by high activity, high resistance to poisoning and capable of operating in a broad range of temperatures, in particular temperatures lower than those typical for Fe-based industrial catalysts.

Catalysts based on the coupling of metals and hydrides are considered promising for the above stated purpose. Examples of such metal-hydride catalysts are disclosed in US 2016/0361712 A1 and US 2018/0327272 A1.

Unfortunately, the properties of current metal-hydride catalysts are not completely satisfactory because the hydride compounds tend to be unstable in air. Indeed, they undergo oxidation in presence of oxygen and also strongly react with water. In addition, the hydrides suffer from thermal degradation at high temperatures and, for this reason, their operative window is restricted to a temperature lower than 400° C.

For the above reasons, another issue of the metal-hydride catalysts involves their preparation process that requires synthesis in a chemically and thermally controlled atmosphere and/or the use of costly equipment, i.e. ball mill tanks.

Therefore, it is highly desirable to provide an improved ammonia synthesis catalyst of the hydride type that can be prepared and handled in air under mild conditions. It is also highly desirable to provide a simpler, less expensive and less energy intensive process to synthesize said catalyst.

### SUMMARY OF THE INVENTION

The invention aims to overcome the above drawbacks of the prior art concerning the unsatisfactory resistance of the conventional hydride catalysts to high temperature as well as to O₂ and H₂O containing environments that typically restrain the choice of the preparation process.

A further aim is to provide a process for producing ammonia catalysts which is conveniently scalable for industrial production.

Accordingly, one aspect of the present invention is a process for synthesizing an ammonia synthesis catalyst according to claim 1.

The process comprises the steps of: providing a transition metal precursor preferentially selected from one of Fe, Co, Ru, Mn or V (and optionally mixtures thereof) and contacting said transition metal precursor with a solution or a solvent (preferably, an aqueous or organic solvent, more preferably an aqueous solvent, even more preferably water or distilled water) to form a modified solution; providing a catalyst support and contacting said catalyst support with said modified solution to form a suspension; desiccating said suspension to obtain a solid powder; optionally subjecting said solid powder to a purification step to obtain a purified solid powder; mixing said solid powder or said high purity solid powder with a hydride compound.

The hydride catalyst of the invention is synthesized with a low energy consumption because the mixing between the solid powder and the hydride compound can be carried out in open-air and at room temperature thus not requiring the use of pressure-sealed vessels and the synthesis in a chemically and thermally controlled environment.

The process is particularly suited for large scale production because pressure-sealed vessels are not required for carrying out the synthesis and the process also allows an excellent control over the metal loading preventing the occurrence of metal leaching phenomena and enabling an optimal distribution of the transition metal over the catalytic support.

A second aspect of the present invention is an ammonia synthesis catalyst obtainable with the process of the invention.

A catalyst according to the invention comprises a transition metal, a catalyst support and a hydride compound wherein said transition metal is preferentially selected from Fe, Co, Ru, Mn or V and said catalyst support is selected from one or more of the following oxide CeO₂, SiO₂, doped-SiO₂, TiO₂, doped-TiO₂, ZrO₂, doped-ZrO₂, ZnO, Pr₂O₃, Nb₂O₅, La₂O₃, CaO·Al₂O₃, mayenite, LaCeOₓ, BaTiO₃, BaCeO₃, BaCeₓY₁₋ₓO₃, SrTiO₃, CaTiO₃, LaCoO₃, BaZrO₃, Y₂O₃, LaScSi, MCM-41 (ordered mesoporous silica), silicalite-1 (crystalline silica) or ZSM-5 (zeolite), and optionally their mixtures.

In the prior art, it is believed that, as supported by the work carried out by Wang, Peikun et al. in “Breaking Scaling Relations to Achieve Low-Temperature Ammonia Synthesis through LiH-Mediated Nitrogen Transfer and Hydrogenation.” Nature chemistry 9.1 (2017): 64-70, a close contact between the metal nanoparticles and a hydride is required to ensure the transfer of nitrogen that has been activated on the metal to the hydride so to enable a high ammonia production rate.

In the present invention and contrary to the teaching of the prior art, the applicant has found that by depositing metal nanoparticles onto a support and afterwards adding a hydride via simple mechanical mixing, an enhanced catalytic activity can be surprisingly obtained.

Moreover, it has also been found that the obtained catalyst exhibits an improved on-stream stability as the support can promote the resistance against sintering which typically occurs when the metal is directly deposited on the hydride.

Still a further advantage is that compared to conventional hydride catalysts a lower hydride content is required to achieve comparable ammonia productivity. Furthermore, the partial substitution of the hydride with an inexpensive support further reduces its manufacturing cost.

Additionally, performing the mixing of the hydride compound with the powder comprising the metal compound deposited over metal oxide support in a predetermined order, in particular mixing the hydride with the powder only after the preparation of the latter has been completed prevents the degradation of the hydride during the synthesis.

Besides, in the initial preparation stage of the ammonia catalyst the powder can be produced with the desired mechanical and structural properties prior to the addition of the hydride compound. This is advantageous because processing the powder to obtain desired properties is more challenging once the hydride has been added.

A further aspect of the present invention is the use of the catalyst of the invention for synthesizing ammonia by reacting a make-up gas containing nitrogen and hydrogen on said catalyst. Advantageously, ammonia can be synthesized with high productivity due to the enhanced activity of the catalysts.

Hereinafter the term “transition metal”, if not otherwise specified, denotes a chemical element in the d-block of the periodic table (groups 3 to 12, preferably groups from 5 to 9, even more preferably groups 5, 7, 8 or 9).

The term “catalyst precursor” or in short “precursor” denotes a substance that requires activation or reaction to produce the active catalyst. It follows that the combined term “transition metal precursor” indicates a chemical element in the d-block of the periodic table—according to the above definition—which is not yet catalytically active, e.g. it does not show substantial catalytic activity, but it requires further activation or reaction to be transformed into an active catalyst.

In the present description a modified solution is a solution wherein the transition metal precursor has been dissolved after having been contacted with the solution or solvent. In other words, the modified solution is a transition metal-containing solution.

Further the term catalyst support denotes a material which is typically in a solid form and characterized by a high surface area that allows to affix or deposit the catalyst over its surface.

The term reducing agent indicates a substance that loses electrons to other substances in a redox reaction and gets oxidized to a higher valency state.

The term precipitation agent denotes a substance which is added to a medium to cause the precipitation of another substance present in the medium. Such precipitation may be a selective precipitation for the substance that has to be precipitated from the medium.

The term inert atmosphere denotes an atmosphere devoid of reactive gases, for instance oxygen. In more details, in the present invention an inert atmosphere indicates an atmosphere that does not affect the synthesis of the catalyst, e.g., it does not induce a chemical or electrochemical reaction or physical interaction between the gases contained in the atmosphere and the catalyst undergoing synthesis. An inert atmosphere may be obtained with nitrogen, argon or helium as inert gases.

In the present description the expression “nanoparticles” means particles with a mean particle size distribution comprised from 1 nanometre (nm) to 1000 nm. Such mean particle size distribution may be determined with known analysis methods, such as laser diffraction.

### DESCRIPTION OF THE INVENTION

The process of the present invention is very versatile because it can be implemented to synthesize ammonia catalysts from various support types and from various hydride compounds.

For instance, the catalyst support can be selected from one or more of the following oxides: CeO₂, SiO₂, doped-SiO₂, TiO₂, doped-TiO₂, ZrO₂, doped-ZrO₂, ZnO, Pr₂O₃, Nb₂O₅, La₂O₃, CaO·Al₂O₃, mayenite, LaCeOₓ, BaTiO₃, BaCeO₃, BaCeₓY₁₋ₓO₃, SrTiO₃, CaTiO₃, LaCoO₃, BaZrO₃, Y₂O₃, LaScSi, MCM-41 (ordered mesoporous silica), silicalite-1 (crystalline silica) or ZSM-5 (zeolite), and optionally their mixtures.

According to a particularly preferred embodiment, said catalyst support is TiO₂ or SiO₂.

The hydride compound may be represented by the formula X—Hₙ wherein X is an alkali metal or alkali-earth metal (preferably one of the following: Li, Na, K, Ca, Ba or Sr), and n is the number of atoms of hydrogen in the hydride.

The mixing between the solid powder or the purified solid powder with the hydride compound can be carried out in any suitable conditions and with any suitable processes known to the skilled person but according to a particularly interesting application the mixing between said solid powder or said purified solid powder and the hydride compound does not need to be performed in an inert controlled atmosphere and for instance, it can be performed in open-air or ambient air at room temperature.

Ambient air indicates atmospheric air in its natural state containing typically 78% nitrogen and 21% oxygen and minor components. The possibility to carry out the mixing between the solid powder or the purified solid powder with the hydride compound in ambient air allows to drastically reduce the synthesis cost of the catalyst which is particularly beneficial for large-scale production applications.

The applicant found that better catalytic performances were obtained when the said powder or said purified solid powder was mixed with the hydride compound in a 60:40 weight ratio. Other less preferred weight ratios are from 100:1 to 1:100.

The process of the invention can further include the step of contacting the modified solution with a reducing agent or with a precipitating agent prior to contact said modified solution with the catalytic support.

Alternatively, the process of the invention can further include the step of contacting the suspension obtained by contacting the catalyst support with the modified solution with a reducing agent or with a precipitating agent prior to desiccation.

According to a preferred embodiment, when the precipitating agent is used in the process of the invention instead of the reducing agent, the reduction of the ammonia catalyst is carried out in situ in the ammonia synthesis converter.

Suitable reducing agents to reduce the modified solution or the suspension are sodium borohydride NaBH₄ or potassium borohydride KBH₄. Suitable precipitating agents are an aqueous solution of a carbonate salt or urea. Preferably, said carbonate salt is (NH₄)₂CO₃, Na₂CO₃ or K₂CO₃.

In the art is known that boron can be incorporated during the preparation of the catalyst using for instance NaBH₄ to improve the catalytic activity of the synthesized catalyst. In the present invention when the reducing agent containing boron is used, the reducing agent is not exploited to incorporate boron into the catalyst but it is only used to induce the precipitation of a transition metal over the support. In other words, the reducing agent is only used to transform metal ions (e.g. Co²⁺) into metal nanoparticles (e.g. metallic cobalt) on the support surface and not to incorporate boron therein.

Fe and Co are preferred transition metals. Preferably, said transition metal precursor is a metal salt and/or a metal complex, particularly preferably selected from FeCl₃, Fe(NO₃)₃, Fe(acac)₃ [Iron(III) acetylacetonate], or CoCl₂.

Preferably the purification step includes at least one washing operation. Washing operations can be carried out using distilled water as a washing agent at a temperature in the range of 80 to 95° C. or preferably at a temperature equal to 90° C. Particularly preferably the washing step is carried out to remove the excess of boron which were potentially introduced during the treatment with the reducing agent containing boron. The washing operation can be carried out to remove the excess of boron from the surface of the support leaving only metal nanoparticles. Preferably the content of boron remaining in the purified solid powder after purification is equal to or less than 0.5 wt %. This washing step in the catalytic preparation has proven to be beneficial for the catalyst performance during the synthesis of ammonia.

In accordance with the above, an embodiment of said purification step includes reducing a boron content of said solid powder. A residual content of boron remaining in said purified solid after purification is preferably not greater than 0.5 wt %, such as 0 to 0.5 wt % or 0.01 to 0.5 wt % or 0.1 to 0.5 wt %.

The desiccating step can be carried out by filtration on a membrane having a pore size in the range of 0.10 to 0.40 μm, preferably in the range of 0.20 to 0.30 μm, or even more preferably equal to or of about 0.22 μm.

The invention provides a preparation process which is less energy consuming and provides excellent control over the metal loading with no metal leaching. The additional support brings an enhanced activity as well as an improved stability on stream due to resistance towards sintering.

Without being bound by theory, the applicant believes that a synergistic effect due to oxide and hydride phases interconversion, in situ (oxy) nitride phase formation, and improved metal dispersion is responsible for the observed enhanced activity of the investigated catalysts.

According to the invention the ammonia synthesis catalyst comprises a transition metal, a catalyst support, and a hydride compound. Preferably said transition metal consists of nanoparticles that are dispersed and supported on said catalyst support.

In a particularly preferred embodiment, said catalytic support is TiO₂ or SiO₂.

In a particularly preferred form of realization of the invention, no capping agent(s) is/are used to prevent aggregation of nanoparticles during the synthesis of the catalyst. Indeed, the applicant has discovered through electron microscopy investigation that the use of a capping agent is not required to form metal nanoparticles within the catalyst. Widely used capping agents used in the literature, but not used in the present invention, are Cetyltrimethylammonium chloride and citric acid.

According to a particularly preferred embodiment, the process for synthesizing the ammonia synthesis catalyst comprises steps of:
a) providing a salt and/or complex of a transition metal selected from Fe, Co, Ru, Mn, V and mixtures thereof, preferably Fe and/or Co, and contacting said salt and/or complex with an aqueous solvent to form a transition metal-containing solution;
   preferably said salt and/or complex being selected from FeCl₃, Fe(NO₃)₃, Fe(acac)₃, or CoCl₂;
b) providing a catalyst support and contacting said catalyst support with said transition metal-containing solution to form a suspension;
   said catalyst support being selected from CeO₂, SiO₂, doped-SiO₂, TiO₂, doped-TiO₂, ZrO₂, doped-ZrO₂, ZnO, Pr₂O₃, Nb₂O₅, La₂O₃, CaO·Al₂O₃, mayenite, LaCeOₓ, BaTiO₃, BaCeO₃, BaCeₓY₁₋ₓO₃, SrTiO₃, CaTiO₃, LaCoO₃, BaZrO₃, Y₂O₃, LaScSi, MCM-41 (ordered mesoporous silica), silicalite-1 (crystalline silica), ZSM-5 (zeolite), and their mixtures;
   preferably said catalyst support being selected from CeO₂, SiO₂, doped-SiO₂, TiO₂, doped-TiO₂, and their mixtures;
c) desiccating said suspension, preferably by filtration on a membrane, to obtain a solid powder;
d) optionally subjecting said solid powder to a purification step, preferably to at least one washing operation step, to obtain a purified solid powder;
e) mechanically mixing said solid powder or said purified solid powder with an alkali metal or alkali-earth metal hydride in ambient air to yield said ammonia synthesis catalyst, preferably wherein said transition metal is in the form of nanoparticles.

### EXAMPLES

The present invention is now described with reference to the examples and to the comparative examples hereinafter reported.

Examples 1 to 5 describes the preparation process of the ammonia oxidation catalysts obtained according to the process of the invention whilst comparative examples 1 to 6 describes the preparation process of traditional catalysts used for the synthesis of ammonia.

### Example 1: Synthesis of Fe/TiO₂—LiH

In a vessel, 7.14 g tetradecyltrimethylammonium bromide (TTAB, TCl>98%) was dissolved in 47.34 g distilled water. The solution was kept under magnetic stirring at room temperature for 20 min. 0.74 g (20 wt. % Fe) FeCl₃ was added to the TTAB aqueous solution and the mixture was kept under magnetic stirring at room temperature for 10 min. Subsequently, 1.0 g TiO₂ (P25, manufactured by Degussa) used as a support was added and the suspension was kept under magnetic stirring at room temperature for 5 min.

In a separate vessel, 1.6 g NaBH₄ (Merck) was dissolved in 52 g distilled water and kept under magnetic stirring at room temperature for 5 min. Afterwards, the NaBH₄ solution was added dropwise to the aqueous suspension containing TTAB, FeCl₃ and the TiO₂ support. The resulting mixture was allowed to react for 1 h at room temperature under magnetic stirring. The suspension was then filtrated using a 220 nm membrane filter and the solid was washed three times with 25 mL hot distilled water (temperature of ca. 90° C.). The resulting solid was finally dried in air for 48 h. The obtained powder of Fe/TiO₂ was about 1.4 g.

Subsequently, the Fe/TiO₂ powder was mechanically mixed with a LiH powder using a 50:50 weight ratio in a porcelain mortar for 2 min and the resulting powder was stored in a dessicator prior to use. The Fe loading obtained in the Fe/TiO₂—LiH powder was of 10 wt. %.

### Example 2: Synthesis of Fe/SiO₂—LiH

The material was prepared following the procedure hereabove reported in example 1. In this case, TiO₂ support was substituted by SiO₂.

### Example 3: Synthesis of Co/TiO₂—LiH

In a vessel, 7.14 g tetradecyltrimethylammonium bromide (TTAB, TCl>98%) was dissolved in 47.34 g distilled water. The solution was kept under magnetic stirring at room temperature for 20 min. Subsequently, 0.55 g (20 wt. % Co) CoCl₂ (Alfa Aesar, 99.7%, anhydrous) was added to the TTAB aqueous solution and the mixture was kept under magnetic stirring at room temperature for 10 min. Subsequently, 1 g TiO₂ (P25, manufactured by Degussa) used as a support was added and the suspension was kept under magnetic stirring at room temperature for 5 min.

In a separate vessel, 1.52 g NaBH₄ (Merck) was dissolved in 52 g distilled water and kept under magnetic stirring at room temperature for 5 min. Afterwards, the NaBH₄ solution was added dropwise to the aqueous suspension containing TTAB, CoCl₂ and the TiO₂ support. The resulting mixture was allowed to react for 1 h at room temperature under magnetic stirring. Then, the suspension was filtrated using a 220 nm membrane filter and the solid was washed three times with 25 mL hot distilled water (temperature of ca. 90° C.). The resulting solid was finally dried in air for 48 h and further dried under vacuum for 3 h at room temperature. The obtained powder of Co/TiO₂ was about 1.4 g.

Afterwards, the Co/TiO₂ powder was mechanically mixed with a LiH powder using a 50:50 weight ratio in a porcelain mortar for 2 min. The resulting powder was stored in a dessicator prior to use. The Co loading obtained in the Co/TiO₂—LiH powder was of 10 wt. %.

### Example 4: Synthesis of Co/TiO₂—LiH 60:40

The material was prepared following the procedure described in hereinabove reported example 4. In this case, the Co/TiO₂ powder was mechanically mixed with the LiH powder using a 60:40 weight ratio.

### Example 5: Synthesis of Co/TiO₂—LiH D-P

In a vessel, 0.55 g (20 wt. % Co) CoCl₂ was dissolved in 32 g distilled water under stirring. Then, 1 g TiO₂ (P25 manufactured by Degussa) was added. Subsequently, 12.75 ml of 0.5 M (NH₄)₂CO₃ aqueous solution was added dropwise to the suspension and the resulting mixture was stirred in air for 2 h at room temperature. The suspension was filtrated using a 220 nm membrane filter and the solid was washed three times with 15 mL hot distilled water (temperature of ca. 90° C.). The resulting solid was dried in air for 16 h at 110° C. and finally calcined in air at 500° C. for 3 h. The obtained powder of Co/TiO₂ D-P (deposition-precipitation) was about 1.1 g.

### Comparative Example 1: Synthesis of Fe/LiH

The Fe/LiH powder was synthesized following the protocol described in Nature Chem 2017, 9, 64-70.2 g of LiH (Alfa Aesar, >97%) was mixed with 0.659 g (10 wt. % Fe) FeCl₃ (Alfa Aesar, 98%, anhydrous) in a 45 mL stainless-steel grinding bowl. 5 beads of 10 mm diameter were then added (bead-to-sample mass ratio of 10) and the bowl was sealed. The latter was subsequently introduced in a Pulverisette 7 Premium Line (Fritsch) planetary ball-mill operating at 200 rpm. The sample was ball-milled for 3 h (6 cycles of 30 min with inversion of the rotation direction between each cycle) and was next washed three times with 50 mL THF (Roth, 99.5%) in order to remove LiCl. The sample was dried under vacuum for 3 h at room temperature and stored in a desiccator prior to use. The obtained Fe/LiH powder was about 2.3 g.

### Comparative Example 2: Synthesis of Co/LiH

The Co/LiH powder was synthesized following the procedure report in comparative example 1 with the exception that CoCl₂ (Alfa Aesar, 99.7%, anhydrous) was used as a metal precursor instead of FeCl₃.

### Comparative Example 3: Synthesis of Cs—Ru/CeO₂

The Ru/CeO₂ powder was synthesized in the same manner as Fe/TiO₂ in example 1 except that CeO₂ was used as support instead of TiO₂ and Ru(NO)(NO₃)₃ was used as metal precursor instead of FeCl₃.

The CeO₂ support was prepared according to the procedure described in ACS Sustainable Chem. Eng. 2018, 6, 13867-13876. In a glass vessel, 63.70 g NH₄Ce(NO₃)₆ was dissolved in 212.35 g distilled water. In a separate vessel, 106.17 g urea was dissolved in 212.35 g distilled water. Both solutions were kept under magnetic stirring for 10 min at room temperature. The urea aqueous solution was then added to the NH₄Ce(NO₃)₆ aqueous solution and the resulting mixture was heated at 100° C. for 6 h under magnetic stirring. Next, the suspension was filtrated and the solid was washed four times with 100 mL hot distilled water (temperature of ca. 90° C.). The powder was then dried overnight under vacuum at 110° C. and finally calcined in air at 550° C. for 3 h (5° C./min ramp). The obtained powder of CeO₂ was about 20 g and was kept in a dessicator prior to use.

0.17 g of Ru(NO)(NO₃)₃ (5 wt. % Ru) was introduced in the TTAB aqueous solution and the resulting mixture was kept under magnetic stirring for 30 min at 30° C. After adding 1 g CeO₂, a solution made of 0.89 g NaBH₄ dissolved in 52 g distilled water was added dropwise and the resulting suspension was stirred for 1 h at room temperature. The rest of the synthesis was the same as in example 1. The Ru/CeO₂ powder obtained was about 1.05 g.

The Cs promoter was introduced via wet impregnation process using a Cs-to-Ru molar ratio of 2. First, 0.20 g CsNO₃ (Cs to Ru molar ratio of 2) was dissolved in 50 g distilled water and the solution was kept under magnetic stirring for 10 min at room temperature. Then, the Ru/CeO₂ powder was added to the CsNO₃ aqueous solution and the resulting suspension was kept under magnetic stirring for 15 min and subsequently sonicated for 30 min at room temperature. The solvent was then removed by evaporation using a Büchi Rotavapor R-200 apparatus operating at 50° C. and 80 rpm. The obtained powder of Cs—Ru/CeO₂ was about 1.2 g and was kept in a dessicator prior to use.

Comparative Example 4: Synthesis of Cs—Ru/Al₂O₃

The Cs—Ru/Al₂O₃ powder was synthesized in the same manner as in Comparative example 3 except that the CeO₂ support was replaced by Al₂O₃ and that the Cs-to-Ru molar ratio was adjusted to 10.

### Comparative Example 5: Ru/C

Ru/C is a standard commercially available catalyst.

Comparative Example 6: Fe/CeO₂—Li₃N

The Fe/CeO₂—Li₃N powder was synthesized in the same manner as in Example 1 except that CeO₂ was used as support instead of TiO₂ and LiH was replaced by Li₃N.

### Ammonia Productivity Calculation

After synthesis, the catalysts were tested in a reactor to generate ammonia and the ammonia productivity for each catalyst were calculated according to the procedure hereinafter reported.

0.12 mL of catalyst powder was mixed with 0.12 mL of glass beads (350-500 μm diameter) and arranged in a stainless-steel fixed bed reactor.

The fixed bed reactor was supplied with nitrogen (N₂, Air Liquide, 5.0 purity) and with hydrogen (H₂, Air Liquide, 5.0 purity). The flow rate of gas was set to N₂: 20 mL/min and H₂: 60 mL/min, the gas hourly space velocity GHSV was 40,000 h⁻¹.

The pressure was kept at 5 bar and the catalyst was first treated at 350° C. for 3 h under the N₂:H₂ gas mixture. The temperature was then successively decreased to 300° C. and 250° C. while keeping the temperature constant for at least 1 h on each temperature plateau.

The effluent gas of the reactor of the flow system was analysed by gas chromatography (GC) and the productivity was subsequently calculated at 350° C.

The calculated productivity value for the comparative example 1 (Fe/LiH) was then used to normalize the productivity value of the other specimens and a percentage productivity value for these latter specimens is reported in Table 1.

In more detail, the percental productivity value for each catalyst was calculated according to the following formula:

$$\% Productivity = ( \frac{{Productivity}_{i}}{{Productivity}_{comparative example 1}} - 1 ) \times 100$$

Where:
Productivityᵢ is the calculated productivity of a catalyst;
Productivity_{comparative example 1} is the calculated productivity of the catalyst reported in the comparative example 1.

TABLE 1

| Specimens | Catalyst | % Productivity |
|---|---|---|
| 1 | Fe/TiO2—LiH | +47% |
| 2 | Fe/SiO2—LiH | +13% |
| 3 | Co/TiO2—LiH | +144% |
| 4 | Co/TiO2—LiH 60:40 | +150% |
| 5 | Co/TiO2—LiH D-P | +117% |
| Comparative example 1 | Fe/LiH | Used as a reference |
| | | for the normalization |
| Comparative example 2 | Co/LiH | −28% |
| Comparative example 3 | Cs—Ru/CeO2 | −53% |
| Comparative example 4 | Cs—Ru/Al2O3 | −95% |
| Comparative example 5 | Ru/C | −19% |
| Comparative example 6 | Fe/CeO2—Li3N | −11% |

Table 1 shows that the % productivities of the catalysts produced according to the process of the invention are noticeably higher than the productivity values calculated for the conventional catalysts (comparative examples 1 to 6) synthesized according to known processes.

The applicant strongly believes that such unexpected enhancement in catalytic activity observed cannot be explained solely by the changes in metal dispersion over the catalytic support because different ammonia production rates were observed when investigating the performance of different catalytic supports having similar textural properties. In conclusion, all the evidence hereinabove reported seem to suggest the existence of an unexpected active role of the support in the catalytic mechanism.

1-19. (canceled)

20. A process for synthesizing an ammonia synthesis catalyst, the process comprising:
a) providing a transition metal precursor, said transition metal precursor being a metal salt and/or a metal complex, and contacting said transition metal precursor with a solution or solvent to form a transition metal-containing solution;
b) providing a catalyst support and contacting said catalyst support with said transition metal-containing solution to form a suspension;
c) desiccating said suspension to obtain a solid powder;
d) subjecting said solid powder to a purification step to obtain a purified solid powder, said purification step includes reducing a boron content of said solid powder;
e) mixing said purified solid powder with a hydride compound to yield said ammonia synthesis catalyst; and
one of the following steps:
contacting said transition metal-containing solution of step a) with a reducing agent prior to step b); or
contacting said suspension of step b) with a reducing agent prior to step c);
said reducing agent being sodium borohydride (NaBH₄) or potassium borohydride (KBH₄); a residual content of boron remaining in said purified solid being not greater than 0.5 wt %.

21. The process according to claim 20, wherein said metal salt and/or a metal complex is selected from FeCl₃, Fe(NO₃)₃, Fe(acac)₃, or CoCl₂.

22. The process according to claim 20, wherein said catalyst support is selected from one or more of CeO₂, SiO₂, doped-SiO₂, TiO₂, doped-TiO₂, ZrO₂, doped-ZrO₂, ZnO, Pr₂O₃, Nb₂O₅, La₂O₃, CaO·Al₂O₃, mayenite, LaCeOₓ, BaTiO₃, BaCeO₃, BaCeₓY₁₋ₓO₃, SrTiO₃, CaTiO₃, LaCoO₃, BaZrO₃, Y₂O₃, LaScSi, MCM-41 silicalite-1 ZSM-5; preferably CeO₂, TiO₂, doped-TiO₂, SiO0₂, or doped-SiO₂.

23. The process according to claim 20, wherein said hydride compound is represented by the formula X—Hₙ wherein X is an alkali metal or alkali-earth metal, preferably Li, Na, K, Ca, Ba or Sr.

24. The process according to claim 20, wherein step e) is not carried out in an inert controlled atmosphere that is an atmosphere devoid of reactive gases.

25. The process according to claim 20, wherein step e) is performed by mechanically mixing said purified solid powder with said hydride compound in a 60:40 weight ratio.

26. The process according to claim 20, wherein said purification step of step d) includes a washing operation.

27. The process according to claim 26, wherein said washing operation is carried out with distilled water at a temperature in a range of 80° C. to 95° C.

28. The process according to claim 20, wherein the desiccation of said suspension of step c) includes the step of filtering said suspension on a membrane having a pore size in the range of 0.10 to 0.40 μm.

29. The process according to claim 20, wherein said residual content of boron is from 0 wt % to 0.5 wt %, from 0.01 wt % to 0.5 wt %, or from 0.1 wt % to 0.5 wt %.

30. The process according to claim 20, further comprising:
a) providing the salt and/or complex of the transition metal selected from Fe, Co, Ru, Mn, V and mixtures thereof, and contacting said salt and/or complex with an aqueous solvent to form a transition metal-containing solution;
said salt and/or complex being selected from FeCl₃, Fe(NO₃)₃, Fe(acac)₃, or CoCl₂;
b) providing the catalyst support and contacting said catalyst support with said transition metal-containing solution to form the suspension;
said catalyst support being selected from CeO₂, SiO₂, doped-SiO₂, TiO₂, doped-TiO₂, ZrO₂, doped-ZrO₂, ZnO, Pr₂O₃, Nb₂O₅, La₂O₃, CaO·Al₂O₃, mayenite, LaCeOₓ, BaTiO₃, BaCeO₃, BaCeₓY₁₋ₓO₃, SrTiO₃, CaTiO₃, LaCoO₃, BaZrO₃, Y₂O₃, LaScSi, MCM-41, silicalite-1, ZSM-5, and their mixtures;
said catalyst support being selected from CeO₂, SiO₂, doped-SiO₂, TiO₂, doped-TiO₂, and their mixtures;
c) desiccating said suspension by filtration on a membrane to obtain the solid powder;
d) subjecting said solid powder to the purification step, preferably to at least one washing operation step, to obtain the purified solid powder;
e) mechanically mixing said purified solid powder with an alkali metal or alkali-earth metal hydride in ambient air to yield said ammonia synthesis catalyst wherein said transition metal is in the form of nanoparticles.

31. The process accoriding to claim 20, wherein the transition metal precursor includes at least one of Fe, Co, Ru, Mn, or V.

32. An ammonia synthesis catalyst obtainable by the process claim 20.

33. A method of using of an ammonia synthesis catalyst for synthesis of ammonia, said ammonia synthesis catalyst including a transition metal, a catalyst support, and a hydride compound wherein:
said transition metal is selected from Fe, Co, Ru, Mn or V; and
said catalyst support is selected from one or more of CeO₂, SiO₂, doped-SiO₂, TiO₂, doped-TiO₂, ZrO₂, doped-ZrO₂, ZnO, Pr₂O₃, Nb₂O₅, La₂O₃, CaO·Al₂O₃, mayenite, LaCeOₓ, BaTiO₃, BaCeO₃, BaCeₓY₁₋ₓO₃, SrTiO₃, CaTiO₃, LaCoO₃, BaZrO₃, Y₂O₃, LaScSi, MCM-41, silicalite-1, or ZSM-5; and
said hydride compound is represented by the following formula X—Hₙ wherein X is Li, Na, K, Ca, Ba or Sr.

34. The method according to claim 33, wherein said transition metal consists of nanoparticles which are dispersed and supported on said catalyst support.

35. The method according to claim 33, wherein said catalyst support is CeO₂, TiO₂, doped-TiO₂, SiO₂ or doped-SiO₂.
